(19) United States
(12) Patent Application Publication
(10) Pub. No.: US 2008/0011565 A1
(43) Pub. Date: Jan. 17, 2008

(54) Pneumatic spring with vibration damper

(75) Inventor: Rainer Jaeckel, Schwebheim (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/827,326

(22) Filed: Jul. 11, 2007

(30) Foreign Application Priority Data
Jul. 12, 2006 (DE) 10 2006 032 208.8

(51) Int. Cl. F16F 9/36

(52) U.S. Cl. 188/322.17

(57) ABSTRACT

A vibration damper includes a cylinder and a piston rod which is free to move back and forth in the cylinder in the axial direction. The piston rod is connected to a component to be damped by a connecting bearing and the cylinder is installed in a sleeve tube. The cylinder has on its outside surface a support ring, which is supported axially on the sleeve tube by a detachable fastening disk, and an additional bearing compensates for angular movement of the component to be damped with respect to the assembly to be supported. The sleeve tube has at one end a bottom piece, to which the additional bearing is attached, and also has an axial support surface facing away from the bottom piece for the support ring. The detachable fastening disk is accessible from the direction of the piston rod.

### BACKGROUND OF THE INVENTION

1. Field of the Invention

The invention relates to a pneumatic spring with a vibration damper.

2. Description of the Related Art

A pneumatic spring with a vibration damper is known from DE 199 59 842 A1. The pneumatic spring comprises a cover, which is connected to a piston rod of the vibration damper by a universal pin joint. Adjoining the cover is a rolling bellows, the end of which is attached to a roll-down tube. The roll-down tube is welded in turn to a pretensioning sleeve, which is screwed to the chassis. The pretensioning sleeve is open at the end facing the chassis, so that, after the fastening disk which pretensions a sealing ring against a vibration damper-side support ring has been removed, the vibration damper can be removed in the downward direction, that is, toward the chassis. The connecting bearing, which is formed by the sealing ring, the pretensioning sleeve, and the fastening disk, is necessary, because the chassis executes angular movement with respect to the vehicle body, and this angular movement is compensated by the pin joint on the piston rod and by the connecting bearing on the vibration damper. Because the connecting bearing performs the double function of “sealing” and “angular mobility”, the only design which can be considered is a universal joint.

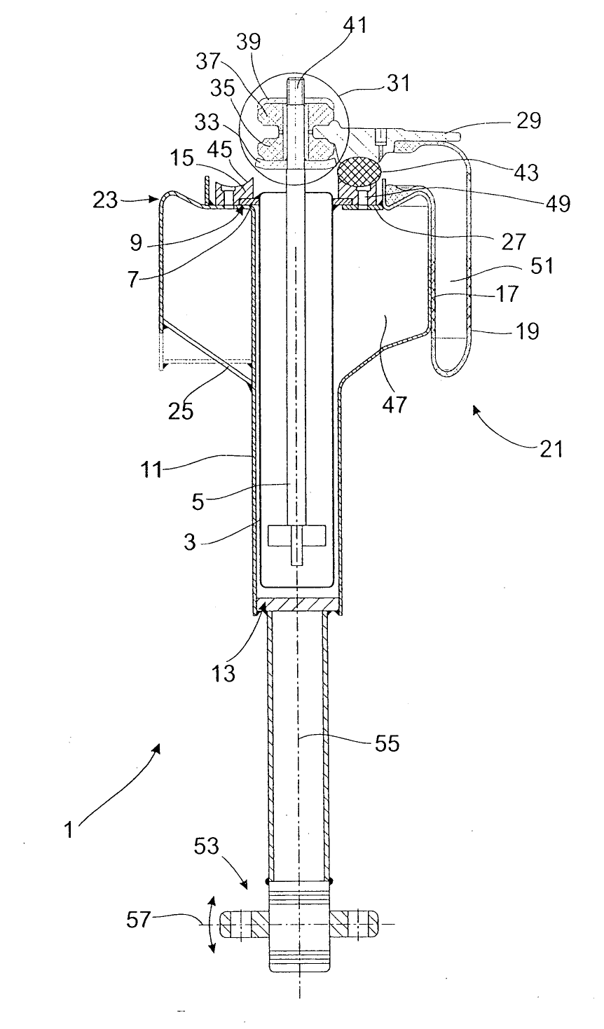

EP 0 000 287 A1 relates to a pneumatic spring with a coaxial vibration damper. In the embodiment according to FIG. 2, a rotary joint is used between the piston rod of the vibration damper and a completely closed bottom piece of the roll-down tube of the pneumatic spring. The vibration damper cannot be removed from the pneumatic spring until after the pneumatic spring itself has been removed.

A vibration damper is known from DE 28 49 100 A1, which is guided in an outer tube. A pivot is formed on the side of the outer tube. A pin joint connection to a shock absorber cylinder is provided at the end facing the vehicle body. The piston rod of the vibration damper is screwed to a bottom piece of the outer tube. The screw joint is readily accessible, so that, after the screw joint has been unscrewed, the vibration damper can be pulled out of the outer tube in the direction toward the tube's upper end. In many cases, an annular bearing is required instead of the lateral pivot to connect the vibration damper to, for example, a vehicle axle. An annular bearing, however, cannot be used in this case because of the need to have access to the bottom piece of the outer tube.

### SUMMARY OF THE INVENTION

An object of the present invention is to realize a replaceable vibration damper, in which a connecting bearing of any desired type can be used.

According to the invention, this object is accomplished in that the sleeve tube has a bottom piece at one end, to which the additional bearing is attached, and also has an axial support surface for the support ring, facing away from the bottom piece, where the detachable fastening disk is accessible from the direction of the piston rod.

The great advantage is that, through the use of a bottom piece, which is not required for the axial attachment of the vibration damper, any desired connecting bearing can be used, that is, even an annular bearing. In addition, the vibration damper can be removed in the upward direction, that is, in the direction toward the component to be damped. This removal direction is often more convenient for the mechanic and easier to use than to remove it in the direction of the component being supported, e.g., the wheel of the vehicle.

In a further advantageous embodiment, a radial gap is present between the inside surface of the sleeve tube and the cylinder of the vibration damper. A slight slant between the support ring and the cylinder of the vibration damper can be easily tolerated without any negative effect on the functionality of the vibration damper.

According to an advantageous embodiment, the piston rod is in working connection with a compression stop spring, which comes to rest against a stop surface provided by the fastening disk

In addition, the sleeve tube also performs an additional function, in that it has a roll-down contour for the rolling bellows of a pneumatic spring.

In another advantageous embodiment, the piston rod is connected to the cover of a pneumatic spring by a pin joint, where the pin joint has two elastomeric elements, one supported below, the other above, the pneumatic spring cover. The pin joint can be disconnected very easily, so that the pneumatic spring cover can also be removed to allow the vibration damper to be pulled out of the sleeve tube.

It is also possible for the top piece of the sleeve tube to form an annular space, which is connected by means of at least one opening to a spring space, bounded by the rolling bellows.

Other object and feature of the present invention will become apparent from the following detailed description considered in conjunction with the accompanying drawing. It is to be understood, however, that the drawing is designed solely for purposes of illustration and not as a definition of the limits of the invention, for which reference should be made to the appended claims. It should be further understood that the drawing is not necessarily drawn to scale and that, unless otherwise indicated, it is merely intended to conceptually illustrate the structure and procedure described herein.

### BRIEF DESCRIPTION OF THE DRAWINGS

The invention is described in greater detail on the basis of the following description of the FIGURE.

The sole FIGURE is a schematic cross-section view of a vibration damper unit in accordance with the present invention.

### DETAILED DESCRIPTION OF THE PREFERRED EMBODIMENTS

The single FIGURE shows a vibration damper 1 of any design with a cylinder 3 and a piston rod 5, which is free to move back and forth in the cylinder in the axial direction. At the end where the piston rod exits, the cylinder 3 has a circumferential support ring 7, which rests on the support surface 9 of a sleeve tube 11. The sleeve tube 11 holds the cylinder 3 and has a closed bottom piece 13 at the end. The support surface 9 on the sleeve tube 11 faces away from the direction of the bottom piece 13. A fastening disk 15, which is screwed to the support surface 9 of the sleeve tube 11, acts on the top surface of the support ring 7. Thus the fastening disk 15 is accessible from the direction of the piston rod 5 for installation or removal of the vibration damper 1. A radial gap is present between the inside surface of the sleeve tube 11 and the cylinder 3 of the vibration damper 1, so that a certain tilt of the support ring 7 has no negative effect on the functionality of the vibration damper.

The sleeve tube 11 has a roll-down contour 17 for a rolling bellows 19 of a pneumatic spring 21. In the left half of the figure, the roll-down contour is formed by an outwardly rounded collar 23, which is stabilized radially from the inside by a welded-in support ring 25. This variant is easy to manufacture. In the right half of the cross section, the sleeve tube 11 is used which has a welded-in support disk 27 on the inside diameter with the support surface 9 for the support ring 7.

The other end of the rolling bellows 19 is supported on a pneumatic spring cover 29, which is connected to the piston rod 5 by a connecting bearing 31 mounted on the piston rod, this bearing being designed in the form of a pin joint. The pin joint has a lower joint disk 33 on a shoulder of the piston rod 5. The joint disk 33 holds a lower elastomeric body 35, which rests on the bottom and/or inside surface of the pneumatic spring cover 29. The pin joint also has an upper elastomeric body 37 and an upper joint disk 39, which are mirror images of the lower elements with respect to the plane of the pneumatic spring cover. The pin joint can be pretensioned by a threaded stud 41 on the piston rod 5.

A compression stop spring 43 designed as an elastomeric ring is in working connection with the pneumatic spring cover 29 and thus with the piston rod 5. This stop spring comes to rest on a stop surface 45 of the fastening disk 15 as a function of the stroke.

The top piece of the sleeve tube 11 forms an annular space 47, which is connected to a spring space 51 of the pneumatic spring 21 by at least one opening, e.g., an opening 49 in the fastening disk 15.

In addition to the connecting bearing 31 at the piston rod end, the vibration damper 1 also has another bearing 53, which is attached to the bottom piece 13 and which establishes the connection between the damper 1 and a supporting component. In cases where the vibration damper 1 is used for the passenger compartment, the supporting component could be a vehicle axle or the vehicle frame. In the FIGURE, a ring-shaped bearing is shown, which makes angular motion with respect to the longitudinal axis 55 of the vibration damper 1 possible as well as a rotational movement around a transverse axis 57.

When the vibration damper 1 reaches its wear limit, the pneumatic spring 21 can be opened very easily by removing the upper joint disk 39; by taking off the upper elastomeric element 37, and by lifting away the pneumatic spring cover 29. Now fastening screws (not shown) between the fastening disk 15 and the support surface 9 of the sleeve tube 11 are accessible, so that the fastening disk 15 can also be removed. Then the vibration damper 1, which is supported in both axial directions by its support ring 7 on the sleeve tube 11, can be pulled out of the sleeve tube 11.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A vibration damper unit for damping a component relative to a supporting assembly, comprising:
a sleeve tube having a lower end piece and an axial support surface which faces away from the lower end piece;
a detachable fastening disk fastened to the support surface;
a cylinder comprising an outside surface and a support ring extending outward from the outside surface, the cylinder being disposed in the sleeve tube with the support ring being axially supported on the support surface of the sleeve tube by the fastening disk;
a piston rod axially movable in the cylinder;
a first bearing for connecting the piston rod to the component; and
a second bearing for connecting the sleeve tube to the supporting assembly, the second bearing being attached to the lower end piece and configured to compensate angular movement of the component relative to the supporting assembly,
wherein the detachable fastening disk is accessible along an axial direction of the piston rod.

2. The vibration damper unit of claim 1, wherein there is a radial gap between the sleeve tube and the cylinder.

3. The vibration damper unit of claim 1, further comprising a compression stop spring which comes to rest against a stop surface of the fastening disk, the piston rod being in working connection with the compression stop spring.

4. The vibration damper unit of claim 1, further comprising a pneumatic spring comprising a rolling bellows, the sleeve tube having a roll-down contour for the rolling bellows.

5. The vibration damper unit of claim 4, wherein the pneumatic spring further comprises a cover, the first bearing comprising a pin joint having two elastomeric elements, wherein the cover of the pneumatic spring is supported between the two elastomeric elements so that the piston rod is in working connection with the cover of the pneumatic spring by the pin joint.

6. The vibration damper unit of claim 4, wherein the pneumatic spring defines a spring space and the fastening disk has a through-opening, the sleeve tube comprising an upper piece which defines the roll-down contour and an annular space which is in communication with the spring space by the through-opening.

7. The vibration damper unit of claim 1, wherein the detachable fastening disk is accessible from the component's side.
